(19) United States
(12) Patent Application Publication
(10) Pub. No.: US 2024/0322585 A1
(43) Pub. Date: Sep. 26, 2024

(54) Method and System for Operating an Electrically Driven Working Device With at Least One Battery Pack, and Battery Pack

(71) Applicant: Andreas Stihl AG & Co. KG, Waiblingen (DE)

(72) Inventors: Daniel SAUERTEIG, Kernen im Remstal (DE); Christian SIGLE, Weinstadt (DE); Simon DIETRICH, Waiblingen (DE); Raphael WEGMANN, Leonberg (DE); Tobias SCHMIDT, Bondorf (DE)

(21) Appl. No.: 18/615,302

(22) Filed: Mar. 25, 2024

(30) Foreign Application Priority Data
Mar. 23, 2023 (EP) 23163689.5

(51) Int. Cl. H02J 7/00

(52) U.S. Cl. CPC H02J 7/00712; H02J 7/00034; H02J 7/0013; H02J 7/0047; H02J 7/0063

(57) ABSTRACT

A method operates an electrically driven working device with at least one battery pack that is intended to supply the working device with electric drive power, wherein the working device and the battery pack are electrically connected to one another in detachable fashion for power supply purposes. The working device is selected from a set of different working devices able to be electrically connected to the battery pack in detachable fashion, which working devices differ in terms of a respective power consumption variable, and/or the working device has different operating modes that differ in terms of a respective power consumption variable. At least one power consumption variable, in particular during operation of the working device with the battery pack, is at least temporarily higher than a continuous power output variable of the battery pack. The method transmits a request for power consumption variable information from the working device to the battery pack, provides a response from the battery pack to the working device on the basis of the transmitted request, and operates the working device on the basis of the provided response.

### CROSS REFERENCE TO RELATED APPLICATION

This application claims priority under 35 U.S.C. § 119 from European Patent Application No. 23 163 689.5, filed Mar. 23, 2023, the entire disclosure of which is herein expressly incorporated by reference.

### BACKGROUND AND SUMMARY

The invention relates to a method and to a system, in particular each, for operating an electrically driven working device with at least one battery pack, and to a battery pack for such a system.

The invention is based on the problem of providing a method and a system for operating an electrically driven working device with at least one battery pack, said method and system having improved properties, and in particular enabling an increase in performance. The invention is also based on the problem of providing a battery pack for such a system.

The invention solves this problem by providing a method, a system and a battery pack as described in the independent claims. Advantageous developments and/or refinements of the invention are described in the dependent claims.

The method according to the invention is for operating an electrically driven working device with at least one battery pack, in particular multiple battery packs. The battery pack is intended to supply the working device with electric drive power. The working device and the battery pack are electrically connected to one another in detachable fashion for power supply purposes. The working device is selected from a set of different working devices able to be electrically connected to the battery pack in detachable fashion. The working devices differ in terms of a respective power consumption variable. In addition or as an alternative, the working device has different operating modes. The operating modes differ in terms of an, in particular the, respective power consumption variable. At least one power consumption variable is at least temporarily higher than a continuous power output variable of the battery pack, in particular during operation of the working device with the battery pack. The method comprises the following steps: a) transmitting or communicating a request for power consumption variable information from the working device to the battery pack; b) providing a response from the battery pack to the working device on the basis of the transmitted request; and c) operating the working device on the basis of the provided response, in particular by way of the working device.

This makes it possible to operate the working device with a power consumption variable that may be at least temporarily higher than the continuous power output variable. This thus makes it possible to increase performance or to increase the usable battery pack performance.

In particular, the method, the operation, the power supply, the transmission and/or the provision may be automatic and/or computer-implemented.

The working device and/or the battery pack may be mobile or portable. In particular, mobile may mean a mass of at most 50 kg (kilograms), in particular at most 20 kg, in particular at most 10 kg, in particular at most 5 kg, and/or at least 0.2 kg, in particular at least 0.5 kg, in particular at least 1 kg, in particular at least 2 kg.

The working device may have a treatment tool and/or an electric drive motor, in particular for driving the treatment tool. In particular, the drive power may be for the drive motor. In addition or as an alternative, the working device may be ground-guided and/or hand-operated, in particular hand-held, and/or a gardening, forestry, construction and/or cultivation device.

The battery pack may have a plurality of battery cells. In particular, the battery cells may each be individual rechargeable electrochemical-based storage elements for electrical energy. In addition or as an alternative, the battery cells may be lithium-ion battery cells. Again in addition or as an alternative, the battery cells may be identical, in particular of identical type and/or structure. Again in addition or as an alternative, a respective cell voltage, in particular cell rated voltage, of a respective one of the battery cells may be at least 2 V (volts) and/or at most 4.2 V, in particular 3.6 V. Again in addition or as an alternative, the battery cells may be round cells, prismatic cells or pouch cells.

The working device and the battery pack may have detachable electrical power contacts for power supply purposes, and in particular detachable electrical communication contacts for transmission and/or provision purposes. In addition or as an alternative, the connection may be contact-based or the power contacts, and in particular the communication contacts, may be intended to make contact with one another. Again in addition or as an alternative, the power contacts, and in particular the communication contacts, may have, in particular be, plug connectors. Again in addition or as an alternative, the constituent term “terminal” may be used synonymously for the constituent term “contact”.

The working device and the battery pack may be mechanically connected to one another in detachable fashion for power supply purposes.

Detachable may mean detachable without tools, without destruction and/or able to be detached by a user.

The term “coupled” may be used synonymously for the term “connected”.

The working device and the battery pack may be intended for removal and/or exchange of the battery pack, in particular by the user. In particular, the working device may have a battery bay, wherein the battery bay may be intended to receive the battery pack.

At one time, either the battery pack and the working device or the battery pack and another working device may be connected to one another for power supply purposes.

At one time, the working device may be in either one operating mode or another operating mode.

The power consumption variable may be a maximum power consumption variable or a peak power consumption variable.

The power consumption variable may be a power consumption or a variable corresponding to the power consumption, such as for example a current consumption.

The continuous power output variable may be a continuous power output or a variable corresponding to the continuous power output, such as for example a continuous current output.

The continuous power output variable may be a continuous power output variable that is not time-limited, in particular until the battery pack is empty or until an end of discharge parameter, such as for example an undervoltage limit value, is attained.

The power consumption and/or the continuous power output may be the drive power.

The power consumption variable and/or the continuous power output variable may have a value.

The term “designed”, “configured” or “set up” may be used synonymously for the term “intended”.

The term “comprises” may be used synonymously for the term “has” or “contains”.

The request, the power consumption variable information and/or the response may comprise a content item.

The term “demand” or “query” may be used synonymously for the term “request”.

Transmitting the request may be referred to as requesting.

Providing the response may comprise receiving or communicating the response from the battery pack to the working device. In particular, communicating the response may be referred to as responding.

The term “control” may be used synonymously for the term “operate”.

The phrase “based on” may be used synonymously for the phrase “on the basis of”.

The transmission or step a) may be carried out by way of a transmission unit, in particular of the working device.

The provision or step b) may be carried out by way of a provision unit, in particular of the battery pack.

The operation or step c) may be carried out by way of an operating unit, in particular of the working device.

Step b) may take place at a time after step a). In addition or as an alternative, step c) may take place at a time after step b).

The phrase “are carried out” may be used synonymously for the term “take place”.

In one development of the invention, the request comprises the power consumption variable, and in particular a duration variable. For the duration variable, the power consumption variable should be available from the battery pack. Providing the response comprises determining a power consumption variable available from the battery pack, and in particular an available duration variable. For the available duration variable, the available power consumption variable is available from the battery pack. The working device is operated at most with a power consumption variable corresponding to the available power consumption variable at least temporarily, in particular at most for a duration variable corresponding to the available duration variable. This allows the request to be different or specific, in particular for the working device and/or the operating mode, and thus allows the same for the provision of the response and thus the operation. In addition or as an alternative, this makes it possible not to exceed the available power consumption variable, and in particular the available duration variable. This thus makes it possible to comply with constraints, in particular cell specifications, of the battery pack. In particular, the request may be saved, in particular stored, in the working device, in particular a storage unit of the working device. In addition or as an alternative, the working devices and/or the operating modes may differ in terms of a respective duration variable. Again in addition or as an alternative, the duration variable may be a duration or a variable corresponding to the duration. Again in addition or as an alternative, the duration variable may be a minimum and/or limited duration variable and/or have a value. Again in addition or as an alternative, the term “able to be provided” may be used synonymously for the term “available”. Again in addition or as an alternative, the phrase “power output variable able to be provided” may be used synonymously for the phase “available power consumption variable”. Again in addition or as an alternative, the term “precession” may be used synonymously for the term “response”. Again in addition or as an alternative, the response may comprise the available power consumption variable, and in particular the available duration variable and/or the continuous power output variable. Again in addition or as an alternative, the determination may be automatic and/or computer-implemented. Again in addition or as an alternative, the term “equal to” may be used synonymously for the term “corresponding to”.

In one refinement of the invention, the available power consumption variable, and in particular the available duration variable, is determined based on parameters of a characteristic curve of a power output variable over a duration variable that is defined by the battery pack. This enables the response to be particularly specific. In particular, the parameters may have a value. In addition or as an alternative, the parameters may be saved, in particular stored, in the battery pack, in particular a storage unit of the battery pack. Again in addition or as an alternative, the term “interpolation point” may be used synonymously for the term “parameter”. Again in addition or as an alternative, the term “specified” may be used synonymously for the term “defined”.

In one development of the invention, the transmission of the request triggers the provision of the response. In addition or as an alternative, the response comprises the parameters of the characteristic curve of the power output variable over the duration variable that is defined by the battery pack. The method comprises the following step: determining the power consumption variable available from the battery pack, and in particular the available duration variable for which the available power consumption variable is available from the battery pack, based on the provided response by way of the working device, in particular a determination unit of the working device. The working device is operated at most with the power consumption variable corresponding to the available power consumption variable at least temporarily, in particular at most for the duration variable corresponding to the available duration variable. This enables the response to be particularly specific. In addition or as an alternative, this enables the operation to be varied or specific, in particular for the working device and/or the operating mode. Again in addition or as an alternative, this makes it possible not to exceed the available power consumption variable, and in particular the available duration variable. This thus makes it possible to comply with constraints, in particular cell specifications, of the battery pack. In particular, the triggering and/or the determination may be automatic and/or computer-implemented. In addition or as an alternative, the method may comprise the following step: determining the continuous power output variable based on the provided response by way of the working device. Again in addition or as an alternative, the parameters may be saved, in particular stored, in the working device, in particular a storage unit of the working device.

It would also be possible for the battery pack to provide the parameters without the request being transmitted, in particular to do so at all times or cyclically over time and/or until the working device confirms the provision. This could be an independent invention.

In one refinement of the invention, as the duration variable increases, the power output variable is constant in a first range, decreases in a second range and is constant in a third range, in particular corresponds to the continuous power output variable. In particular, the second range may directly adjoin the first range and/or the third range may directly adjoin the second range. In addition or as an alternative, as the duration variable increases, the power output variable may decrease exponentially or hyperbolically or linearly or incrementally in the second range.

In one refinement of the invention, the determination takes place such that, in decreasing order of priority, first of all the duration variable is attained, second of all the power consumption variable, if possible, otherwise at least a maximum power consumption variable available from the battery pack for the in particular attained duration variable, is attained, but not more, and third of all the in particular attained duration variable is maximized, if possible This, in particular the attaining of the duration variable in any case, means that, if a typical working process is able to be started by way of the working device owing to a sufficient power consumption variable, this should be able to be finished. And if the power consumption variable is not sufficient, the working process should not even be able to be started in the first place. In particular, this may be surprisingly advantageous over carrying out a determination such that, in decreasing order of priority, first of all the power consumption variable, if possible, otherwise at least a maximum power consumption variable available from the battery pack, is attained, and second of all the duration variable, if possible, otherwise a maximum duration variable available from the battery pack for the in particular attained power consumption variable, is attained. This is because the working operation would not be able to be finished in this case. In particular, the duration variable may be maximized to an, in particular stored, maximum duration variable value. This may enable a complete response.

In one refinement of the invention, the method comprises: ascertaining, in particular detecting, an actual power consumption variable of the operation. Determining an available remaining duration variable for which the available power consumption variable is available from the battery pack, on the basis of the ascertained actual power consumption variable. The operation takes place on the basis of the determined remaining duration variable, in particular when the remaining duration variable is equal to zero, such that at least the continuous power output variable, in particular a power output variable that is reduced compared to the continuous power output variable and that is indicated by the response and/or is determined based on the parameters, is not exceeded. This makes it possible to comply with constraints, in particular cell specifications, of the battery pack. In addition or as an alternative, this, in particular the reduced power output variable, makes it possible to compensate for operation with the power consumption variable higher than the continuous power output variable. In particular, a working device that is never operated with the power consumption variable higher than the continuous power output variable and/or that is not operated until the remaining duration variable is equal to zero may be operated with the continuous power output variable, in particular without a time limit or continuously, in particular until the battery pack is empty or until an end of discharge parameter, such as for example an undervoltage limit value, is attained. In addition or as an alternative, the power consumption variable might not or does not need to be a temperature, in particular of the battery pack, since this may be too sluggish. Again in addition or as an alternative, the term “measure” may be used synonymously for the term “detect”. Again in addition or as an alternative, the ascertaining and/or the determination may be automatic and/or computer-implemented and/or take place continuously or cyclically or repeatedly. Again in addition or as an alternative, the term “precess” may be used synonymously for the term “determine”. Again in addition or as an alternative, the remaining duration variable may decrease, in particular starting from the determined available duration variable, if the power consumption variable is higher than the continuous power output variable. Again in addition or as an alternative, the remaining duration variable may increase, in particular again, if the power consumption variable is lower than the continuous power output variable. Again in addition or as an alternative, the remaining duration variable may remain the same if the power consumption variable is equal to the continuous power output variable.

In particular, the actual power consumption variable may be ascertained by way of the battery pack. In addition or as an alternative, the remaining duration variable may be determined by way of the working device.

In one refinement of the invention, the actual power consumption variable is ascertained by way of the working device, in particular a sensor system of the working device. The method in particular comprises: transmitting the ascertained actual power consumption variable from the working device to the battery pack. In addition or as an alternative, the remaining duration variable is determined by way of the battery pack, in particular a determination unit of the battery pack. The method in particular comprises: Providing the determined remaining duration variable from the battery pack to the working device. This, in particular the ascertaining of the actual power consumption variable by way of the working device, allows the above for the battery pack, which has no possibility of carrying out its own ascertaining. In particular, the transmission and/or the provision may be automatic and/or computer-implemented and/or take place continuously or cyclically or repeatedly.

In one refinement of the invention, the remaining duration variable is determined based on an actual power consumption variable/duration variable integration, in particular with weighting, of the determined actual power consumption variable with respect to the continuous power output variable. In particular, this may be referred to as a current-time counter. Reference is also made to the specialist literature.

In one development of the invention, the working devices are an arborist chainsaw, a felling and delimbing chainsaw, an angle grinder and/or a blower. In addition or as an alternative, the operating modes are a delimbing operating mode and/or a felling operating mode. In particular, the power consumption variable may be highest and in particular the duration variable may be shortest for the arborist chainsaw, and/or the power consumption variable may be lowest and in particular the duration variable may be longest for the blower. In addition or as an alternative, the power consumption variable may be highest and in particular the duration variable may be shortest for the delimbing operating mode, and/or the power consumption variable may be lowest and in particular the duration variable may be longest for the felling operating mode.

In one development of the invention, the request is transmitted in a manner triggered by connecting the working device and the battery pack to one another and/or by actuating a user-actuatable operating element, in particular a start button, of the working device and/or by switching between the operating modes, in particular carried out by the user. In particular, the transmission may take place initially or once. In addition or as an alternative, electronics of the working device may be woken up in a manner triggered by the actuation, and the transmission may take place in a manner triggered by the wake-up. Again in addition or as an alternative, the switching may take place in a manner triggered by actuating a user-actuatable switching operating element of the working device.

In particular, the operation may take place in a manner triggered by, in particular on the basis of, actuation, in particular adjustment, of a user-actuatable, in particular user-adjustable, operational operating element of the working device. Reference is also made to the specialist literature.

In one development of the invention, the battery pack is selected from a set of different battery packs able to be electrically connected to the working device in detachable fashion. The battery packs differ in terms of an, in particular the, respective continuous power output variable.

The system according to the invention is for operating the electrically driven working device with at least the battery pack. The battery pack is intended to supply the working device with electric drive power. The working device and the battery pack are electrically connected to one another in detachable fashion for power supply purposes. The working device is selected from the set of different working devices able to be electrically connected to the battery pack in detachable fashion. The working devices differ in terms of the respective power consumption variable. In addition or as an alternative, the working device has the different operating modes. The operating modes differ in terms of the respective power consumption variable. The at least one power consumption variable, in particular during operation of the working device with the battery pack, is at least temporarily higher than the continuous power output variable of the battery pack. The system comprises the transmission unit, the provision unit and the operating unit. The transmission unit is intended to transmit the request for the power consumption variable information from the working device to the battery pack. The provision unit is intended to provide the response from the battery pack to the working device on the basis of the transmitted request. The operating unit is intended to operate the working device on the basis of the provided response. The system may enable the same advantage(s) as for the method mentioned above. In particular, the system may be intended, in particular automatically, to carry out the method as mentioned above. In addition or as an alternative, the system, the transmission unit, the provision unit and/or the operating unit may be electrical and/or have, in particular be, a computing unit and/or a processor and/or a microcontroller and/or a storage unit and/or a computer.

In one development of the invention, the system comprises the working device and/or the battery pack. In particular, the working device and/or the battery pack may be provided in the same way as mentioned above for the method.

The battery pack according to the invention is for the system as mentioned above.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 schematically shows an exemplary system according to the invention comprising an electrically driven working device and a battery pack for operating the working device with the battery pack;

FIG. 2 schematically shows an exemplary method according to the invention for operating the working device with the battery pack, comprising determining a power consumption variable available from the battery pack and an available duration variable based on parameters of a characteristic curve of a power output variable over a duration variable;

FIG. 3 schematically shows the system and the method comprising the determination by way of the battery pack;

FIG. 4 schematically shows an actual power consumption variable of the operation over time and a remaining duration variable for which the available power consumption variable is available from the battery pack, as a function of the actual power consumption variable over time; and

FIG. 5 schematically shows the system and the method comprising the determination by way of the working device.

### DETAILED DESCRIPTION OF THE DRAWINGS

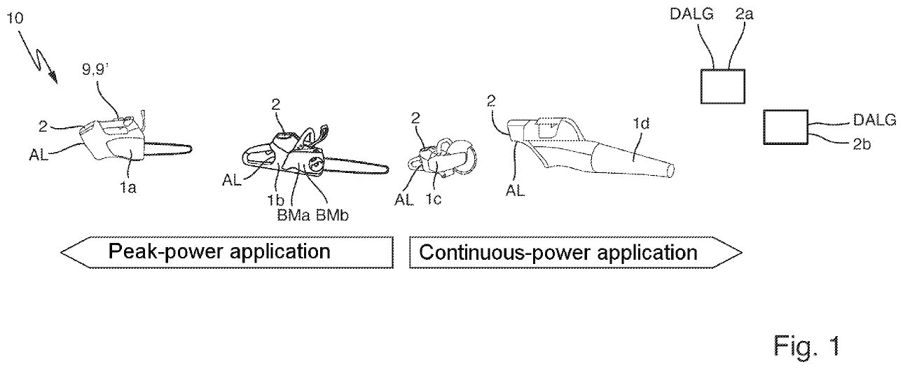

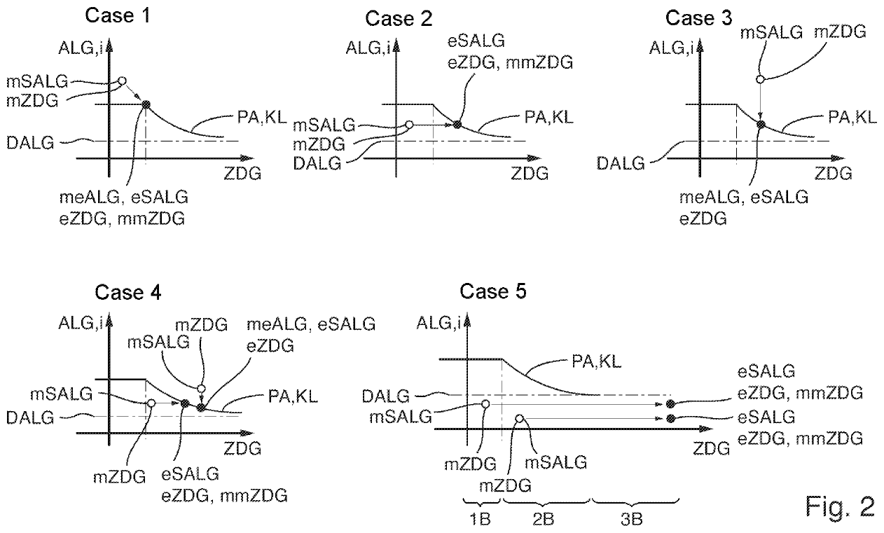

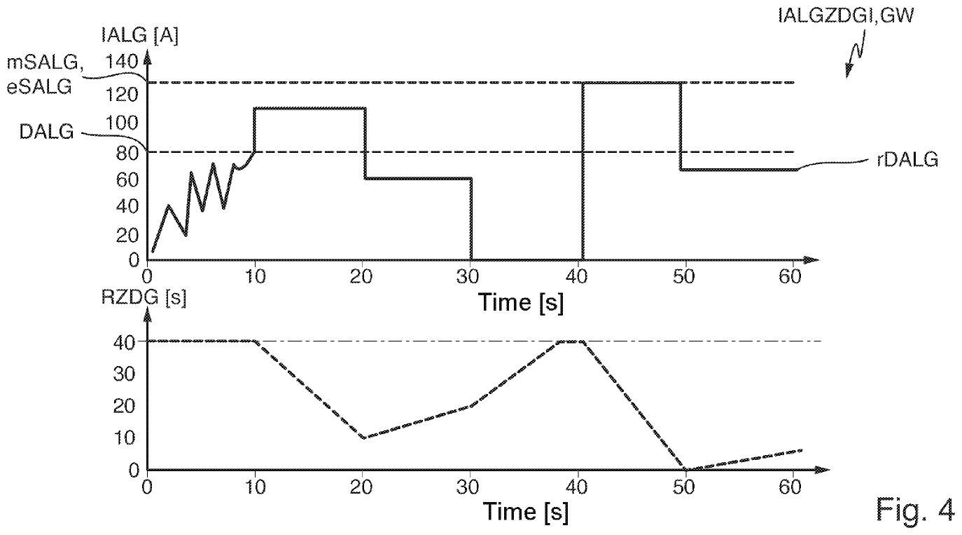

FIGS. 1 to 5 show a system 10 and a method for operating an electrically driven working device 1 with at least one battery pack 2. The battery pack 2 is intended to supply, in particular supplies, the working device 1 with electric drive power AL. The working device 1 and the battery pack 2 are electrically connected to one another in detachable fashion for power supply purposes. The working device 1 is selected from a set of different working devices 1a, 1b, 1c, 1d able to be electrically connected to the battery pack 2 in detachable fashion, as shown in FIG. 1. The working devices 1a-d differ in terms of a respective power consumption variable mSALG. In addition or as an alternative, the working device 1 has different operating modes BMa, BMb, as shown in FIG. 1. The operating modes BMa-b differ in terms of the respective power consumption variable mSALG. At least one power consumption variable mSALG, in particular during operation of the working device 1 with the battery pack 2, is at least temporarily higher than a continuous power output variable DALG of the battery pack 2, as shown in FIGS. 2 and 4.

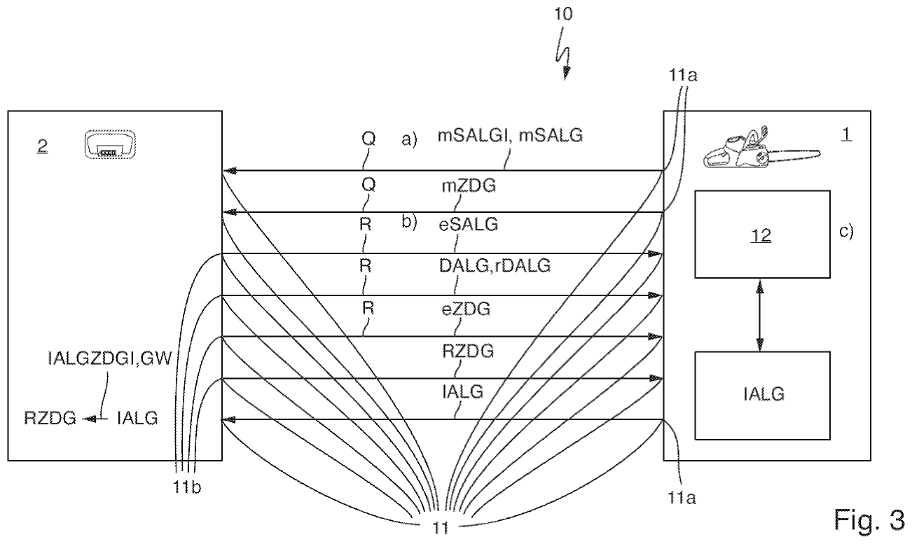

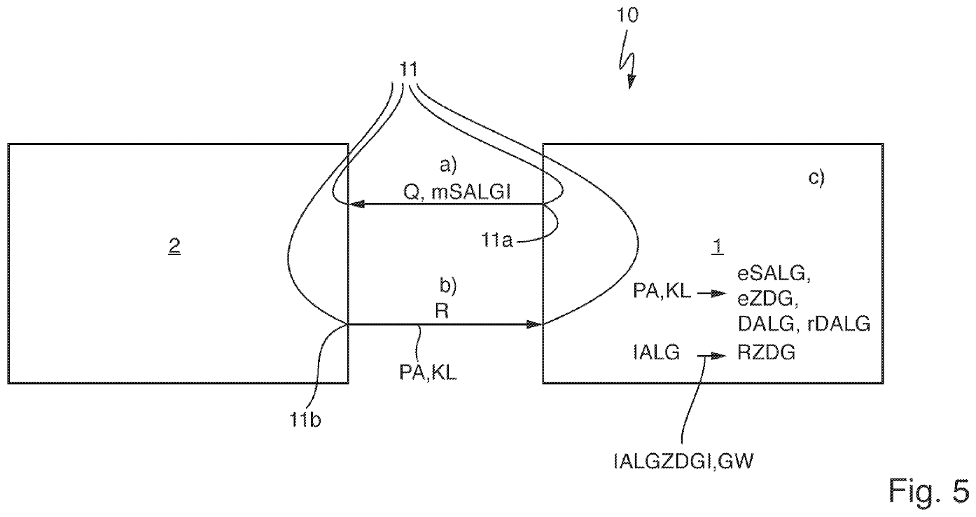

The system 10 comprises a transmission unit 11a, in particular a communication unit 11 of the system 10, a provision unit 11b, in particular of the communication unit 11, and an operating unit 12, as shown in FIGS. 3 and 5. The transmission unit 11a is intended to transmit, in particular transmits, a request Q for power consumption variable information mSALGI from the working device 1 to the battery pack 2. The provision unit 11b is intended to provide, in particular provides, a response R from the battery pack 2 to the working device 1 on the basis of the transmitted request Q. The operating unit 12 is intended to operate, in particular operates, the working device 1 on the basis of the provided response R.

In detail, the system 10 comprises the working device 1 and/or the battery pack 2.

The method comprises the following steps: a) transmitting the request Q for the power consumption variable information mSALGI from the working device 1 to the battery pack 2; b) providing the response R from the battery pack 2 to the working device 1 on the basis of the transmitted request Q; and c) operating the working device 1 on the basis of the provided response R.

In FIG. 3, the request Q comprises the power consumption variable mSALG, and in particular a duration variable mZDG. For the duration variable mZDG, the power consumption variable mSALG should be available from the battery pack 2. Providing the response R comprises determining a power consumption variable eSALG available from the battery pack 2, and in particular an available duration variable eZDG. For the available duration variable eZDG, the available power consumption variable eSALG is available from the battery pack 2. The working device 1 is operated at most with a power consumption variable corresponding to the available power consumption variable eSALG at least temporarily, in particular at most for a duration variable corresponding to the available duration variable eZDG.

In detail, the available power consumption variable eSALG, and in particular the available duration variable eZDG, is determined based on parameters PA of a characteristic curve KL of a power output variable ALG over a duration variable ZDG that is defined by the battery pack 2, as shown in FIG. 2.

In FIG. 5, the transmission of the request Q triggers the provision of the response R. In addition or as an alternative, the response R comprises the parameters PA of the characteristic curve KL of the power output variable ALG over the duration variable ZDG that is defined by the battery pack 2. The method comprises the following step: determining the power consumption variable eSALG available from the battery pack 2, and in particular the available duration variable eZDG for which the available power consumption variable eSALG is available from the battery pack 2, based on the provided response R by way of the working device 1, as shown in FIG. 2. The working device 1 is operated at most with the power consumption variable corresponding to the available power consumption variable eSALG at least temporarily, in particular at most for the duration variable corresponding to the available duration variable eZDG.

In detail, as the duration variable ZDG increases, the power output variable ALG is constant in a first range 1B, decreases in a second range 2B and is constant in a third range 3B, in particular corresponds to the continuous power output variable DALG.

Furthermore, the determination takes place such that, in decreasing order of priority, first of all the duration variable mZDG is attained, second of all the power consumption variable mSALG, at least a maximum power consumption variable meALG available from the battery pack 2 for the duration variable mZDG, is attained, and third of all the duration variable mmZDG is maximized.

The method furthermore comprises: ascertaining, in particular detecting, an actual power consumption variable IALG of the operation, as shown in FIGS. 3 and 5. Determining an available remaining duration variable RZDG for which the available power consumption variable eSALG is available from the battery pack 2, on the basis of the ascertained actual power consumption variable IALG. The operation takes place on the basis of the determined remaining duration variable RZDG, in particular when the remaining duration variable RZDG is equal to zero, such that at least the continuous power output variable DALG, in particular a power output variable rDALG that is reduced compared to the continuous power output variable DALG and that is indicated by the response R and/or is determined based on the parameters PA, is not exceeded, as shown in FIG. 4.

In detail, the actual power consumption variable IALG is ascertained by way of the working device 1.

In FIG. 3, the method comprises: transmitting the ascertained actual power consumption variable IALG from the working device 1 to the battery pack 2.

In addition or as an alternative, the remaining duration variable RZDG is determined by way of the battery pack 2.

In FIG. 3, the method comprises: providing the determined remaining duration variable RZDG from the battery pack 2 to the working device 1.

In FIG. 5, the remaining duration variable RZDG is determined by way of the working device 1.

Furthermore, the remaining duration variable RZDG is determined based on an actual power consumption variable/duration variable integration IALGZDGI, in particular with weighting GW, of the ascertained actual power consumption variable IALG with respect to the continuous power output variable DALG.

In addition, the working devices 1a-d are an arborist chainsaw 1a, a felling and delimbing chainsaw 1b, an angle grinder 1c and/or a blower 1d. In addition or as an alternative, the operating modes BMa-b are a delimbing operating mode BMa and/or a felling operating mode BMb.

Furthermore, the request Q is transmitted in a manner triggered by connecting the working device 1 and the battery pack 2 to one another and/or by actuating a user-actuatable operating element 9, in particular a start button 9′, of the working device 1 and/or by switching between the operating modes BMa-b.

Furthermore, the battery pack 2 is selected from a set of different battery packs 2a, 2b able to be electrically connected to the working device 1 in detachable fashion. The battery packs 2a-b differ in terms of the respective continuous power output variable DALG.

Moreover, an, in particular electrical, rated voltage of the battery pack 2 and/or of the working device 1 is 36 V. In alternative exemplary embodiments, the rated voltage may be less than or more than 36 V, in particular 18 V or 72 V.

In addition or as an alternative, the drive power AL is at least 10 watts (W), in particular at least 100 W, in particular at least 1 kW (kilowatt), in particular at least 2 kW, and/or at most 10 kW, in particular at most 5 kW, in particular 3 kW.

Again in addition or as an alternative, a maximum, in particular electrical, energy content, in particular rated energy content, of the battery pack 2 is at least 50 Wh (watt hours), in particular at least 100 Wh, in particular at least 200 Wh, and/or at most 4000 Wh, in particular at most 2000 Wh, in particular at most 1000 Wh, in particular at most 500 Wh, in particular 337 Wh.

As elucidated by the exemplary embodiments shown and explained above, the invention provides the advantageous method and the advantageous system for operating the electrically driven working device with at least the battery pack, said method and system having improved properties, and in particular enabling an increase in performance. The invention furthermore provides the advantageous battery pack for the system.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for operating an electrically driven working device with at least one battery pack that supplies the working device with electric drive power,
wherein the working device and the battery pack are electrically connected to one another in detachable fashion for supply purposes,
wherein the working device is selected from a set of different working devices able to be electrically connected to the battery pack in detachable fashion, that are different in terms of a respective power consumption variable, and/or wherein the working device has different operating modes that are different in terms of a respective power consumption variable,
wherein at least one power consumption variable, is at least temporarily higher than a continuous power output variable of the battery pack,
the method comprising the steps of:
a) transmitting a request for power consumption variable information from the working device to the battery pack;
b) providing a response from the battery pack to the working device on the basis of the transmitted request; and
c) operating the working device on the basis of the provided response.

2. The method according to claim 1,
wherein the request comprises the power consumption variable,
wherein providing the response comprises determining a power consumption variable available from the battery pack, and
wherein the working device is operated at most with a power consumption variable corresponding to the available power consumption variable at least temporarily.

3. The method according to claim 2, wherein
wherein the request comprises a duration variable for which the power consumption variable should be available from the battery pack,
wherein providing the response comprises determining an available duration variable for which the available power consumption variable is available from the battery pack, and
wherein the working device is operated at most for a duration variable corresponding to the available duration variable.

4. The method according to claim 3, wherein
the available duration variable is determined based on parameters of a characteristic curve of a power output variable over a duration variable which is defined by the battery pack.

5. The method according to claim 1,
wherein the transmission of the request triggers the provision of the response, and/or
wherein the response comprises parameters of a characteristic curve of a power output variable over a duration variable which is defined by the battery pack,
the method further comprising the step of:
determining a power consumption variable available from the battery pack based on the provided response by way of the working device, and
wherein the working device is operated at most with a power consumption variable corresponding to the available power consumption variable at least temporarily.

6. The method according to claim 5, the method further comprising the step of:
determining an available duration variable for which the available power consumption variable is available from the battery pack based on the provided response by way of the working device, and
wherein the working device is operated at most for a duration variable corresponding to the available duration variable.

7. The method according to claim 4, wherein
as the duration variable increases, the power output variable is constant in a first range, decreases in a second range, and is constant in a third range.

8. The method according to claim 3, wherein
the determination takes place such that, in decreasing order of priority, first of all the duration variable is attained, second of all the power consumption variable, at least a maximum power consumption variable available from the battery pack for the duration variable, is attained, and third of all the duration variable is maximized.

9. The method according to claim 3, wherein the method further comprises the steps of:
ascertaining an actual power consumption variable of the operation;
determining an available remaining duration variable for which the available power consumption variable is available from the battery pack on the basis of the ascertained actual power consumption variable; and
wherein the operating takes place on the basis of the determined available remaining duration variable such that at least the continuous power output variable is not exceeded.

10. The method according to claim 9, wherein
the operating takes place on the basis of the determined available remaining duration variable when the remaining duration variable is equal to zero, such that a power output variable which is reduced compared to the continuous power output variable and which is comprised by the response and/or is determined based on the parameters, is not exceeded.

11. The method according to claim 10,
wherein the actual power consumption variable is ascertained by way of the working device, and
wherein the method comprises:
transmitting the ascertained actual power consumption variable from the working device to the battery pack, and/or
wherein the remaining duration variable is determined by way of the battery pack, and
wherein the method comprises:
providing the determined remaining duration variable from the battery pack to the working device.

12. The method according to claim 9, wherein
the remaining duration variable is determined based on an actual power consumption variable/duration variable integration of the ascertained actual power consumption variable with respect to the continuous power output variable.

13. The method according to claim 1, wherein one or both of:
(i) the working devices are an arborist chainsaw, a felling and delimbing chainsaw, an angle grinder and/or a blower, or
(ii) the operating modes are a delimbing operating mode and/or a felling operating mode.

14. The method according to claim 1, wherein
the request is transmitted in a manner triggered by connecting the working device and the battery pack to one another and/or by actuating a user-actuatable operating element of the working device and/or by switching between the operating modes.

15. The method according to claim 1, wherein
the battery pack is selected from a set of different battery packs able to be electrically connected to the working device in detachable fashion and that are different in terms of a respective continuous power output variable.

16. A system for operating an electrically driven working device with at least one battery pack that supplies the working device with electric drive power, wherein the working device and the battery pack are electrically connected to one another in detachable fashion for supply purposes,
wherein the working device is selected from a set of different working devices able to be electrically connected to the battery pack in detachable fashion, that are different in terms of a respective power consumption variable, and/or wherein the working device has different operating modes that are different in terms of a respective power consumption variable,
wherein at least one power consumption variable, during operation of the working device with the battery pack, is at least temporarily higher than a continuous power output variable of the battery pack,
wherein the system comprises:
a transmission unit which transmits a request for power consumption variable information from the working device to the battery pack,
a provision unit which provides a response from the battery pack to the working device on the basis of the transmitted request, and
an operating unit which operates the working device on the basis of the provided response.

17. The system according to claim 16, wherein the system comprises:
the working device and/or the battery pack.

18. A battery pack for use with the system according to claim 16.
